(19) United States
(12) Patent Application Publication
(10) Pub. No.: US 2024/0352925 A1
(43) Pub. Date: Oct. 24, 2024

(54) AIR COMPRESSOR FOR VEHICLE

(71) Applicants: Hyundai Motor Company, Seoul (KR); Kia Corporation, Seoul (KR); Hyundam Industrial Co., Ltd., Asan-si (KR)

(72) Inventors: Seong Cheol CHO, Seoul (KR); Yoon Geun Cho, Daegu (KR); Sung Won Lee, Hwaseong-Si (KR); Je Yeon Kim, Hwaseong-Si (KR); Yong Taek Hwang, Cheonan-Si (KR); Hyun Jin Kang, Cheonan-Si (KR); II Kyu Choi, Cheonan-Si (KR)

(73) Assignees: Hyundai Motor Company, Seoul (KR); Kia Corporation, Seoul (KR); Hyundam Industrial Co., Ltd., Asan-si (KR)

(21) Appl. No.: 18/384,054

(22) Filed: Oct. 26, 2023

(30) Foreign Application Priority Data
Apr. 21, 2023 (KR) 10-2023-0052888

(51) Int. Cl. F04B 27/00; F04B 49/12; F04B 49/22

(52) U.S. Cl. CPC F04B 27/005; F04B 49/125; F04B 49/22

(57) ABSTRACT

An air compressor for a vehicle includes a chamber portion including an inlet and an outlet mounted thereto, and configured to receive air introduced thereinto through the inlet, a joint, mounted inside the chamber portion, connected to a driving motor, and including eccentric circular portions eccentrically coupled to a center shaft in directions providing equal forces to the center shaft, respectively, and piston portions, coupled to the eccentric circular portions, respectively, inserted into a first cylinder and a second cylinder, respectively, the first cylinder and the second cylinder being disposed to face each other inside the chamber portion, and configured to selectively compress air introduced into the cylinders while reciprocating by a discharge process and an intake process performed by rotation of the joint and to discharge the compressed air through the outlet.

### CROSS-REFERENCE TO RELATED APPLICATION

The present application claims priority to Korean Patent Application No. 10-2023-0052888, filed on Apr. 21, 2023, the entire contents of which is incorporated herein for all purposes by this reference.

### BACKGROUND OF THE PRESENT DISCLOSURE

### Field of the Present Disclosure

The present disclosure relates to an air compressor for a vehicle. More particularly, the present disclosure relates to an air compressor for a vehicle in which a dual piston structure, configured to allow intake stroke and discharge stroke to be performed at the same time, is adopted, thus configured for reducing noise and vibration.

### Description of Related Art

Generally, an air compressor used in a vehicle is an air-compressing device configured to intake air from outside and compress the same.

The air compressor generally includes a cylinder and a head, and has a structure in which air taken from outside and stored therein is compressed by reciprocating motion of a piston in the cylinder. Here, the compressed air is temporarily stored in a separate air tank, and is supplied to an appropriate device when needed.

Meanwhile, the air compressed by the air compressor is supplied to and used in various vehicle devices, such as an air suspension, an air washer, and an air conditioner, and the range of its use is gradually increasing.

Accordingly, owing to the increase in use of the compressed air as described above, the capacity of the air compressor is also gradually increasing.

For the present reason, a compressor may be used to supply compressed air to various vehicle devices, and furthermore, to supply eco-friendly alternative fuel such as hydrogen, compressed natural gas (CNG), liquefied petroleum gas (LPG), electricity-based fuel (E-FUEL), etc. to a vehicle at high pressure. Thus it is important to secure competitiveness not only in the weight of the air compressor, but also in durability, cost, and packaging thereof.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an air compressor for a vehicle configured for reducing noise and vibration by adopting a dual piston structure, configured to allow intake stroke and discharge stroke to be performed at the same time, and furthermore, configured for effectively discharging high pressure compressed air by installing an opening and closing valve on each of the pistons, which is opened during an intake process to supply gas introduced into a chamber into a cylinder and is closed during a discharge process to prevent backflow of compressed air inside the cylinder.

Various aspects of the present disclosure are directed to providing an air compressor for a vehicle, the air compressor including a chamber portion including an inlet and an outlet mounted thereto, and configured to receive air introduced thereinto through the inlet, a joint, mounted inside the chamber portion, connected to a driving motor, and including eccentric circular portions eccentrically coupled to a center shaft in directions providing equal forces to the center shaft, respectively, and piston portions, coupled to the eccentric circular portions, respectively, inserted into a first cylinder and a second cylinder, respectively, the first cylinder and the second cylinder being disposed to face each other inside the chamber portion, and configured to selectively compress air introduced into the cylinders while reciprocating by a discharge process and an intake process performed by rotation of the joint and to discharge the compressed air through the outlet.

In an exemplary embodiment of the present disclosure, the eccentric circular portions may include a first-piston-connected eccentric circular portion and a second-piston-connected eccentric circular portion coupled to the center shaft in directions providing the equal forces to the center shaft, respectively.

In another exemplary embodiment of the present disclosure, the piston portions may include a symmetrical structure inside the chamber portion due to the first piston and the second piston being coupled to the first-piston-connected eccentric circular portion and the second-piston-connected eccentric circular portion, respectively.

In yet another exemplary embodiment of the present disclosure, the piston portions may include piston bodies rotatably mounted to the first-piston-connected eccentric circular portion and the second-piston-connected eccentric circular portion, respectively, and extending in a horizontal direction, piston arms coupled to the piston bodies, respectively, and inserted into the first cylinder and the second cylinder, respectively, and intake valves mounted to the piston portions, respectively, and configured to be selectively closed or opened depending on the discharge process or the intake process.

In yet another exemplary embodiment of the present disclosure, the piston arms may correspond to the first cylinder and the second cylinder, respectively, in shape and size, and may each be provided with a sealing member configured to maintain airtightness as the intake valves are mounted.

In still yet another exemplary embodiment of the present disclosure, the piston bodies may be provided with rotary support members, respectively, including internal side portions coupled to surround the first-piston-connected eccentric circular portion and the second-piston-connected eccentric circular portion, respectively, and configured to rotate by rotation of the joint.

In a further exemplary embodiment of the present disclosure, the air compressor may further include discharge-passage-formed portions, coupled to the chamber portion, communicating with the first cylinder and the second cylinder through discharge holes, respectively, and provided with discharge valve plates to control opening and closing of the discharge holes, respectively.

In another further exemplary embodiment of the present disclosure, the discharge valve plates may be provided with discharge valves, respectively, and the discharge valves may close the discharge holes, respectively, during the intake process of the piston portions.

In yet another further exemplary embodiment of the present disclosure, the discharge valve plates may be provided with discharge valves, respectively, and the discharge valves may be opened during the discharge process of the piston portions to open the discharge holes and allow the discharge-passage-formed portions to fluidically-communicate with the outlet.

In yet another further exemplary embodiment of the present disclosure, the air compressor may further include a pressure-equalizing tube, interconnecting the first cylinder and the second cylinder to maintain pressure equalization therein, mounted to the discharge-passage-formed portion communicating with the second cylinder, and extending to the outlet thus guiding air compressed in the second cylinder to be discharged through the outlet.

In still yet another further exemplary embodiment of the present disclosure, the pressure-equalizing tube may guide compressed air to be discharged through the outlet as the second cylinder fluidically-communicates with the discharge-passage-formed portion by the discharge hole being opened during the discharge process of the piston portions.

In a still further exemplary embodiment of the present disclosure, the first-piston-connected eccentric circular portion and the second-piston-connected eccentric circular portion may be positioned to move in directions crossing each other by rotation of the center shaft, thus repeatedly pushing and pulling the piston bodies and allowing reciprocating movement inside the first cylinder and the second cylinder.

Other aspects and exemplary embodiments of the present disclosure are discussed infra.

It is to be understood that the term “vehicle” or “vehicular” or other similar terms as used herein are inclusive of motor vehicles in general, such as passenger vehicles including sports utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

The above and other features of the present disclosure are discussed infra.

### BRIEF DESCRIPTION OF THE DRAWINGS

FIG. 1 is a view schematically illustrating an air compressor for a vehicle according to various exemplary embodiments of the present disclosure;

FIG. 2 is a cross-sectional view taken along line A-A′ in FIG. 1 to illustrate the structure of an air compressor for a vehicle according to various exemplary embodiments of the present disclosure;

FIG. 3 is a cross-sectional view taken along line B-B′ in FIG. 1 to illustrate the structure of an air compressor for a vehicle according to various exemplary embodiments of the present disclosure;

FIG. 4A and FIG. 4B are views exemplarily illustrating a piston portion of an air compressor for a vehicle according to various exemplary embodiments of the present disclosure;

FIG. 5 is a view exemplarily illustrating an intake process performed in an air compressor for a vehicle according to various exemplary embodiments of the present disclosure;

FIG. 6 is a view exemplarily illustrating a discharge process performed in an air compressor for a vehicle according to various exemplary embodiments of the present disclosure;

FIG. 7 is an enlarged perspective view of area an in FIG. 5 to illustrate closing of a discharge hole during the intake process performed in an air compressor for a vehicle according to various exemplary embodiments of the present disclosure; and

FIG. 8 is an enlarged perspective view of area B in FIG. 6 to illustrate opening of a discharge hole during the discharge process performed in an air compressor for a vehicle according to various exemplary embodiments of the present disclosure.

It should be understood that the appended drawings are not necessarily to scale, presenting a somewhat simplified representation of various exemplary features illustrative of the basic principles of the present disclosure. The specific design features of the present disclosure as disclosed herein, including, for example, specific dimensions, orientations, locations, and shapes, will be determined in part by the particular intended application and usage environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Description will now be provided in detail according to exemplary embodiments included herein, with reference to the accompanying drawings.

Advantages and features of the present disclosure, and a method of achieving the same, will be apparent with reference to the exemplary embodiments described below in detail

However, the present disclosure may be embodied in many different forms, and should not be construed as being limited to the embodiments set forth herein. Rather, the embodiments are provided so that the present disclosure will be thorough and complete, and will fully convey the scope of the present disclosure to those skilled in the art. The present disclosure is defined only by the categories of the claims.

In describing the present disclosure, if a detailed explanation of a related known function or construction is considered to unnecessarily obscure the gist of the present disclosure, such explanation has been omitted but would be understood by those skilled in the art.

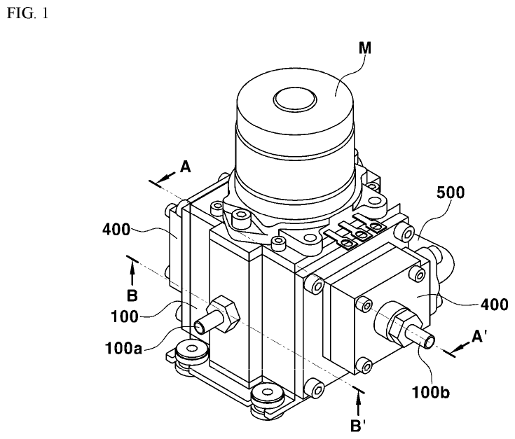

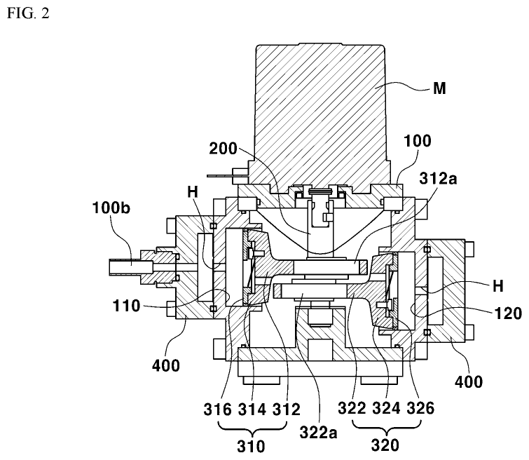

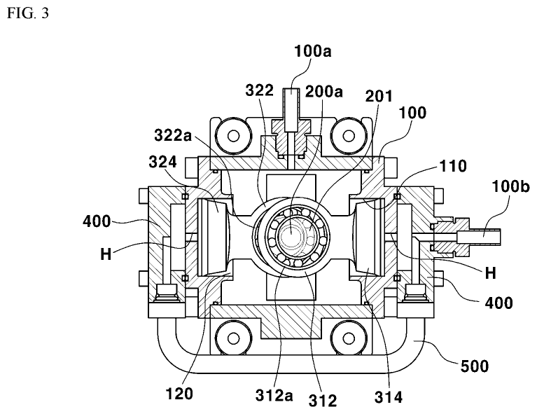

FIG. 1 is a view schematically illustrating an air compressor for a vehicle according to various exemplary embodiments of the present disclosure, FIG. 2 is a cross-sectional view taken along line A-A′ in FIG. 1 to illustrate the structure of an air compressor for a vehicle according to various exemplary embodiments of the present disclosure, and FIG. 3 is a cross-sectional view taken along line B-B′ in FIG. 1 to illustrate the structure of an air compressor for a vehicle according to various exemplary embodiments of the present disclosure.

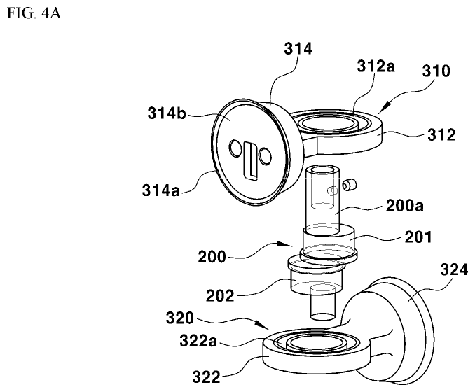

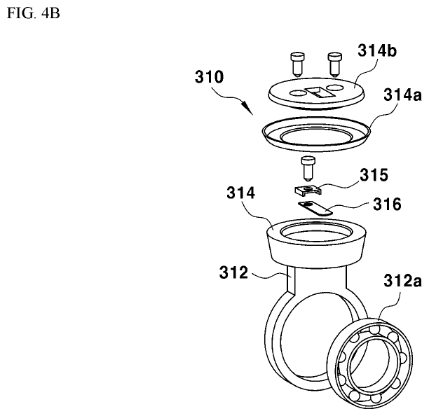

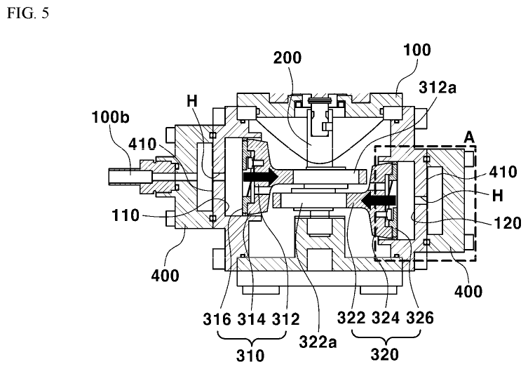

FIG. 4A and FIG. 4B are views exemplarily illustrating a piston portion of an air compressor for a vehicle according to various exemplary embodiments of the present disclosure, FIG. 5 is a view exemplarily illustrating an intake process performed in an air compressor for a vehicle according to various exemplary embodiments of the present disclosure, and FIG. 6 is a view exemplarily illustrating a discharge process performed in an air compressor for a vehicle according to various exemplary embodiments of the present disclosure.

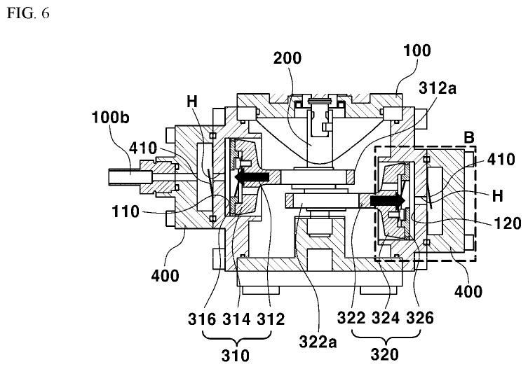

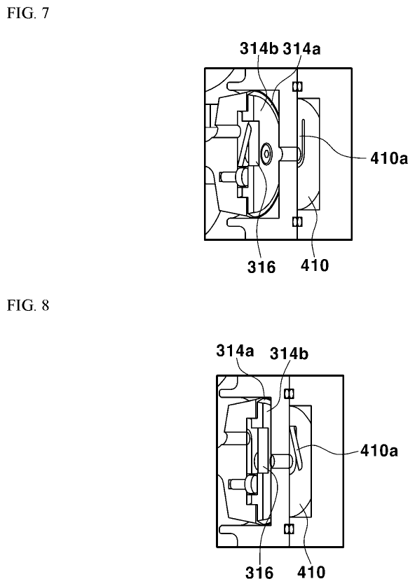

FIG. 7 is an enlarged perspective view of area A in FIG. 5 to illustrate closing of a discharge hole during the intake process performed in an air compressor for a vehicle according to various exemplary embodiments of the present disclosure, and FIG. 8 is an enlarged perspective view of area B in FIG. 6 to illustrate opening of a discharge hole during the discharge process performed in an air compressor for a vehicle according to various exemplary embodiments of the present disclosure.

As illustrated in FIG. 1 and FIG. 2, the air compressor for a vehicle according to the exemplary embodiment of the present disclosure includes a chamber portion 100, a joint 200, and piston portions 300.

The chamber portion 100 includes an inlet 100a and an outlet 100b mounted thereto, and receives air introduced therein through the inlet 100a.

The chamber portion 100 may be adopted in a sensor cleaning system, i.e., an air washer for removing foreign matter through spraying of compressed air or for preventing attachment of foreign matter, and may also be adopted in various vehicle devices for injecting compressed air such as an air suspension or an air conditioner.

Furthermore, the chamber portion 100 may also be provided as a structure for supplying eco-friendly alternative fuel such as hydrogen, compressed natural gas (CNG), liquefied petroleum gas (LPG), electricity-based fuel (E-FUEL), etc. To the vehicle at high pressure.

As illustrated in FIGS. 3, 4A, and 4B, the joint 200 is mounted upright inside the chamber portion 100 to be connected to a driving motor M, and is axially rotatable when the driving motor M is operated.

The joint 200 includes eccentric circular portions each eccentrically coupled to a center shaft 200a in directions providing equal forces to the center shaft 200a, the center shaft 200a being mounted to the driving motor M and to the chamber portion 100. The eccentric circular portions include a first-piston-connected eccentric circular portion 201 and a second-piston-connected eccentric circular portion 202 coupled to the center shaft 200a in directions providing equal forces to the center shaft 200a, respectively.

Here, although it has been described that the eccentric circular portion is provided in a pair, the number thereof is not particularly limited, and if two or more of the same can provide equal forces to the center shaft 200a, the eccentric circular portion may be provided in a larger number.

Accordingly, in the exemplary embodiment of the present disclosure, the joint 200 includes a pair of eccentric circular portions, i.e., the first-piston-connected eccentric circular portion 201 and the second-piston-connected eccentric circular portion 202 configured to provide equal forces to the center shaft 200a when the driving motor M is operated and whereby the center shaft 200a is rotated. Here, the eccentric circular portions may be positioned in directions crossing each other (see FIG. 2 and FIG. 3).

The piston portions 300 are coupled to the first-piston-connected eccentric circular portion 201 and the second-piston-connected eccentric circular portion 202, respectively, and are inserted into a first cylinder 110 and a second cylinder 120, respectively, the first cylinder 110 and the second cylinder 120 being disposed to face each other inside the chamber portion 100.

Furthermore, because the piston portions 300 are positioned so that the first-piston-connected eccentric circular portion 201 and the second-piston-connected eccentric circular portion 202 are positioned to repeatedly cross each other as described above during a discharge process and an intake process performed by the rotation of the joint 200, the piston portions 300 coupled to the first-piston-connected eccentric circular portion 201 and the second-piston-connected eccentric circular portion 202, respectively, reciprocate inside the first cylinder 110 and the second cylinder 120 to selectively compress the air introduced into the chamber portion 100 in the first cylinder 110 and the second cylinder 120 and to discharge the same through the outlet 100b.

Here, the piston portions 300 include a first piston 310 and a second piston 320. The first piston 310 and the second piston 320 are positioned symmetrically inside the chamber portion 100, thus the volume of the piston portions 300 may be increased compared to the conventional structure including one piston, and accordingly, the dead volume thereof may be reduced compared to that of the conventional structure.

The first piston 310 is inserted into the first cylinder 110. The first piston 310 compresses and discharges air introduced into the first cylinder 110, while moving by the discharge process.

The second piston 320 includes a shape identical to a shape of the first piston 310, and is inserted into the second cylinder 120. In the discharge process, the second piston 320 moves in a direction facing the first piston 310 by the first-piston-connected eccentric circular portion 201 and the second-piston-connected eccentric circular portion 202 each eccentrically coupled to the center shaft 200a, as described above, to compress and discharge the air introduced into the second cylinder 120.

As a result, because the first piston 310 and the second piston 320 are coupled to the first-piston-connected eccentric circular portion 201 and the second-piston-connected eccentric circular portion 202, respectively, and include a symmetrical structure inside the chamber portion 100, the first piston 310 and the second piston 320 work together in a state in which forces are balanced while moving by the discharge process and the intake process, reducing noise and vibration.

The first piston 310 and the second piston 320 are provided with piston bodies 312 and 322, piston arms 314 and 324, and intake valves 316 and 326, respectively.

The piston bodies 312 and 322 are rotatably mounted to the first-piston-connected eccentric circular portion 201 and the second-piston-connected eccentric circular portion 202, respectively, and extend in a horizontal direction thereof.

As illustrated in FIG. 3, the piston bodies 312 and 322 may be provided with rotary support members 312a and 322a, respectively, including internal side portions coupled to surround the first-piston-connected eccentric circular portion 201 and the second-piston-connected eccentric circular portion 202, and configured to rotate by the rotation of the center shaft 200a. With the rotatory support members 312a and 322a, vibration and noise generated during movement of the first and second pistons 310 and 320 and the first-piston-connected and second-piston-connected eccentric circular portions 201 and 202 may be reduced, and may also implement a structure configured for isolating vibration.

Because the first-piston-connected eccentric circular portion 201 and the second-piston-connected eccentric circular portion 202 are positioned to move in directions crossing each other by the rotation of the center shaft 200a, the first-piston-connected eccentric circular portion 201 and the second-piston-connected eccentric circular portion 202 repeatedly push and pull the piston bodies 312 and 322 while moving without being fixed thereto, allowing the first piston 310 and the second piston 320 to reciprocate inside the first cylinder 110 and the second cylinder 120, respectively.

Furthermore, the piston arms 314 and 324 are coupled to the piston bodies 312 and 322, respectively, and are inserted into the first cylinder 110 and the second cylinder 120, respectively.

In other words, the piston arms 314 and 324 correspond to the first cylinder 110 and the second cylinder 120, respectively, in shape and size. Furthermore, because the intake valves 316 and 326 are mounted as illustrated in FIG. 4A and FIG. 4B, the piston arms 314 and 324 each may be provided with a sealing member 314a configured to maintain airtightness and a fixing member 314b configured to fix the sealing member 314a.

Furthermore, the intake valves 316 and 326 are fixed to the piston arms 314 and 324, respectively, using a washer 315, and are selectively closed or opened depending on the discharge process or the intake process.

The intake valves 316 and 326 are closed during the discharge process to prevent the air inside the first cylinder 110 and the second cylinder 120 from flowing back to the chamber portion 100. Conversely, the intake valves 316 and 326 are opened during the intake process, allowing air to flow into the first cylinder 110 and the second cylinder 120.

Meanwhile, the air compressor for a vehicle according to the exemplary embodiment of the present disclosure further includes discharge-passage-formed portions 400, coupled to the chamber portion 100, communicating with the first cylinder 110 and the second cylinder 120 through discharge holes H, respectively, and provided with discharge valve plates 410 to control opening and closing of the discharge holes H, respectively.

Here, the discharge valve plates 410 are provided with discharge valves 410a, respectively, and the discharge valves 410a close the discharge holes H, respectively, when the intake valves 316 and 326 of the piston portions 300 are opened during the intake process of the piston portions 300.

Furthermore, the discharge valves 410a of the discharge valve plates 410 are opened as the intake valves 316 and 326 of the piston portions 300 are closed during the discharge process, opening the discharge holes H and allowing the discharge-passage-formed portions 400 to fluidically-communicate with the outlet 100b.

The discharge-passage-formed portion 400 coupled to the first cylinder 110 is directly connected to the outlet 100b (see FIG. 2), thus allowing compressed air to be discharged through the outlet 100b as the discharge hole H is opened by the discharge valve 410a of the discharge valve plate 410. Furthermore, a discharge-passage-formed portion 400 coupled to the second cylinder 120 is connected to a pressure-equalizing tube 500, to be described later (see FIG. 3), thus allowing the compressed air to be discharged through the pressure-equalizing tube 500 as the discharge hole H is opened by the discharge valve 410a of the discharge valve plate 410 and finally be discharged through the outlet 100b.

The pressure-equalizing tube 500 is configured to maintain a constant pressure, i.e., to achieve pressure equalization, between the first cylinder 110 and the second cylinder 120. The pressure-equalizing tube 500 disposed outside the chamber portion 100 may interconnect the first cylinder 110 and the second cylinder 120, fluidically-communicate with the outlet 100b, and guide the compressed air to be discharged in one direction (1-way) to maintain the pressures of the first cylinder 110 and the second cylinder 120 equal.

Hereinafter, referring to FIGS. 7 to 9, the intake process and the discharge process performed based on the configuration of the air compressor for a vehicle according to the exemplary embodiment of the present disclosure, described above, will be described in detail.

### Intake Process

The first piston 310 and the second piston 320 move in opposite directions facing each other, the directions of the arrows in FIG. 5, in the first cylinder 110 and the second cylinder 120, respectively.

Here, taking the second piston 320 as an exemplary embodiment of the present disclosure, because the intake valve 326 is opened and the discharge valve 410a of the discharge valve plate 410 is closed as illustrated in FIG. 7, air may flow through the intake valve 326 and be taken into the second cylinder 120 while the second cylinder 120 is sealed.

Similarly, because the first piston 310 including a structure same as that of the second piston 320 also moves in a direction facing the second piston 320 by the structure of the joint 200 described above, air may be taken into the first cylinder 110.

### Discharge Process

As the joint 200 rotates following the above-described operation, the first piston 310 and the second piston 320 move in opposite directions, the directions of the arrows in FIG. 6, in the first cylinder 110 and the second cylinder 120, respectively.

Here, taking the second piston 320 as an example as same as above, because the intake valve 326 is closed and the discharge valve 410a of the discharge valve plate 410 is opened as illustrated in FIG. 8, air inside the second cylinder 120 in the sealed state is compressed by the movement of the second piston 320 and passes through the discharge hole H, and the compressed air may move through the pressure-equalizing tube 500 to be discharged through the outlet 100b (see FIG. 3).

Similarly, because the first piston 310 including the same structure as the second piston 320 also moves in a direction facing the second piston 320 by the structure of the joint 200 described above, air inside the first cylinder 110 may be compressed and be discharged to the outlet 100b adjacent thereto.

Therefore, in the exemplary embodiment of the present disclosure, when the joint 200 makes one rotation, the first piston 310 and the second piston 320 reciprocate owing to the structure of the first-piston-connected eccentric circular portion 201 and the second-piston-connected eccentric circular portion 202 eccentrically coupled to the joint 200, allowing the intake process and the discharge process to be performed at the same time, and accordingly, the compressed air added from the first cylinder 110 and the second cylinder 120 is discharged together through the outlet 100b, increasing discharge force.

As is apparent from the above description, various aspects of the present disclosure are directed to providing the following effects.

According to an exemplary embodiment of the present disclosure, because a dual piston structure, configured to allow intake stroke and discharge stroke to be performed at the same time, is adopted in an air compressor, and the pistons are eccentrically coupled to a center shaft to balance forces during an operation performed by an intake process and a discharge process, noise and vibration may be reduced.

Furthermore, because an opening and closing valve is provided on each of the pistons, which is opened during the intake process to supply gas introduced into a chamber into a cylinder and is closed during the discharge process to prevent backflow of compressed air inside the cylinder, high pressure compressed air may be effectively discharged through an outlet.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An air compressor apparatus for a vehicle, the air compressor apparatus comprising:
a chamber portion including an inlet and an outlet mounted thereto, and configured to receive air introduced thereinto through the inlet;
a joint, mounted inside the chamber portion, connected to a driving motor, and including eccentric circular portions eccentrically coupled to a center shaft in directions providing equal forces to the center shaft, respectively; and
piston portions, coupled to the eccentric circular portions, respectively, inserted into corresponding cylinders, respectively, and configured to selectively compress air introduced into the corresponding cylinders while reciprocating by a discharge process and an intake process performed by rotation of the joint and to discharge the compressed air through the outlet.

2. The air compressor apparatus of claim 1,
wherein the corresponding cylinders includes a first cylinder and a second cylinder, and
wherein the piston portions, coupled to the eccentric circular portions, respectively, are inserted into the first cylinder and the second cylinder, respectively, the first cylinder and the second cylinder being disposed to face each other inside the chamber portion, and configured to selectively compress the air introduced into the first and second cylinders.

3. The air compressor apparatus of claim 2, wherein the eccentric circular portions include a first-piston-connected eccentric circular portion and a second-piston-connected eccentric circular portion coupled to the center shaft in directions providing the equal forces to the center shaft, respectively.

4. The air compressor apparatus of claim 3,
wherein the first piston and the second piston are coupled to the first-piston-connected eccentric circular portion and the second-piston-connected eccentric circular portion, respectively, and
wherein the piston portions include a symmetrical structure inside the chamber portion due to the first piston and the second piston being coupled to the first-piston-connected eccentric circular portion and the second-piston-connected eccentric circular portion, respectively.

5. The air compressor apparatus of claim 3, wherein the piston portions include:
piston bodies rotatably mounted to the first-piston-connected eccentric circular portion and the second-piston-connected eccentric circular portion, respectively, and extending in a horizontal direction thereof;
piston arms coupled to the piston bodies, respectively, and inserted into the first cylinder and the second cylinder, respectively; and
intake valves mounted to the piston portions, respectively, and configured to be selectively closed or opened depending on the discharge process or the intake process.

6. The air compressor apparatus of claim 5, wherein the piston arms correspond to the first cylinder and the second cylinder, respectively, in shape and size, and are each provided with a sealing member configured to maintain airtightness as the intake valves are mounted.

7. The air compressor apparatus of claim 5, wherein the piston bodies are provided with rotary support members, respectively, including internal side portions coupled to surround the first-piston-connected eccentric circular portion and the second-piston-connected eccentric circular portion, respectively, and configured to rotate by rotation of the joint.

8. The air compressor apparatus of claim 2, further including discharge-passage-formed portions, coupled to the chamber portion, communicating with the first cylinder and the second cylinder through discharge holes, respectively, and provided with discharge valve plates to control opening and closing of the discharge holes, respectively.

9. The air compressor apparatus of claim 8, wherein the discharge valve plates are provided with discharge valves, respectively, and the discharge valves close the discharge holes, respectively, during the intake process of the piston portions.

10. The air compressor apparatus of claim 8, wherein the discharge valve plates are provided with discharge valves, respectively, and the discharge valves are opened during the discharge process of the piston portions to open the discharge holes and allow the discharge-passage-formed portions to fluidically-communicate with the outlet.

11. The air compressor apparatus of claim 8, further including:
a pressure-equalizing tube, interconnecting the first cylinder and the second cylinder to maintain pressure equalization therein, mounted to the discharge-passage-formed portion communicating with the second cylinder, and extending to the outlet thus guiding air compressed in the second cylinder to be discharged through the outlet.

12. The air compressor apparatus of claim 11, wherein the pressure-equalizing tube guides compressed air to be discharged through the outlet as the second cylinder fluidically-communicates with the discharge-passage-formed portion by the discharge hole being opened during the discharge process of the piston portions.

13. The air compressor apparatus of claim 5, wherein the first-piston-connected eccentric circular portion and the second-piston-connected eccentric circular portion are positioned to move in directions crossing each other by rotation of the center shaft, thus repeatedly pushing and pulling the piston bodies and allowing reciprocating movement inside the first cylinder and the second cylinder.
